(19) United States
(12) Patent Application Publication
(10) Pub. No.: US 2009/0226097 A1
(43) Pub. Date: Sep. 10, 2009

(54) IMAGE PROCESSING APPARATUS

(75) Inventors: Nobuyuki MATSUMOTO, Inagi-shi (JP); Takashi IDA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/397,747

(22) Filed: Mar. 4, 2009

(30) Foreign Application Priority Data
Mar. 5, 2008 (JP) 2008-055348

(51) Int. Cl. G06K 9/48; G06K 9/32

(52) U.S. Cl. 382/199; 382/300

(57) ABSTRACT

An image processing apparatus for converting a low-resolution image into a high-resolution image. When a target pixel is located in an edge region, evaluation values relating to similarity between the target pixel and candidate pixels along a proximate line adjacent to the target pixel are calculated. A distribution of the evaluation values along each of the proximate lines by using an approximate function. Based on the value of the approximate function, a corresponding position of the target pixel on each of the proximate lines is calculated. A pixel value of the new pixel based on the pixel value of the target pixel and a distance between the new pixel and the specified line segments.

The entire disclosure of Japanese Patent Application No. 2008-055348 filed on Mar. 5, 2008 including specification, claims, drawings and abstract is incorporated herein by reference in its entirety.

### BACKGROUND OF THE INVENTION

1. Field of the Invention

The present invention relates to image processing apparatus and method for converting image data into high-resolution image data.

2. Description of the Related Art

In recent years, high-resolution TV receivers and displays having a large number of pixels have been spreading. TV receivers and displays perform conversion from the number of pixels of image data to that of the panel and display resulting image data.

Among known methods for converting original image data into image data having a larger number of pixels, that is, being higher in resolution, are an interpolation method which performs filtering using a sinc function that is based on the sampling theorem (3D convolution method, bicubic method, or the like) and an interpolation method which utilizes a pattern-adaptive filter. In the interpolation method utilizing a pattern-adaptive filter, interpolation pixel values are calculated while switching is made among filtering processes according to the pattern of a reference frame (i.e., a subject frame to be increased in resolution). Luminance values of a high-resolution image are interpolated while filter switching is made between regions in which a pattern has vertical/horizontal directivity and regions in which a pattern has oblique directivity. For example, if a filter judges that a pattern in the vicinity of a pixel interpolation position has oblique directivity, an estimation pixel value to be interpolated is calculated from the values of adjacent pixels in a pattern direction shown by the filter.

In the above technique, the direction of a pattern of image data is estimated to be equal to the direction of one of filters prepared in advance and an interpolation pixel value is calculated from the values of adjacent pixels in the estimated direction. Therefore, estimated edge directions may be rounded into discrete angles according to the directions of the filters prepared. This results in stepwise, discontinuous patterns (hereinafter referred to as “jaggies”) at edges whose directions are deviated from the directions of the filters prepared, thereby deteriorating the image quality of a converted high-resolution image.

Furthermore, in the edge detection by filters, directions may not be detected with high accuracy because of influence of noise pixels etc.

### SUMMARY OF THE INVENTION

The present invention has been made in the above circumstances, and provides an image processing apparatus and a related method which enable processing for producing a sharp, high-image-quality, high-resolution image having only a small number of jaggies.

The invention provides an image processing apparatus for converting a low-resolution image into a high-resolution image, including: a determination module configured to determine a target pixel located in an edge region where a pixel value variation rate in the low-resolution image exceeds a given value in the vicinity of the target pixel; an extraction module configured to extract candidate pixels from pixels on each of proximate lines that are adjacent to the target pixel; an evaluation module configured to calculate evaluation values each relating to similarity between the target pixel and each of the candidate pixels with respect to pixel values; an approximation module configured to assume approximation functions, each representing a distribution of the evaluation values along each of the proximate lines by using a function; a position calculation module configured to calculate a corresponding position of the target pixel on each of the proximate lines using each of the approximation function; a segment setting module configured to set line segments connecting each of the corresponding positions and the target pixel; a specifying module configured to specify at least one of the line segments located in the vicinity of a new pixel in the high-resolution image; and a calculation module configured to calculate a pixel value of the new pixel based on the pixel value of the target pixel and a distance between the new pixel and the specified line segments.

### BRIEF DESCRIPTION OF THE DRAWINGS

Embodiment may be described in detail with reference to the accompanying drawings, in which:

FIG. 1 is a block diagram of an image processing apparatus according to a first embodiment;

FIG. 2 is a flowchart of an example operation of the image processing apparatus according to the first embodiment;

FIG. 3 shows an edge region detecting method;

FIG. 4 shows the positions of a target pixel and candidate pixels;

FIG. 5 shows a target pixel region and a candidate pixel region that are used in calculating a corresponding position;

FIG. 6 shows a central candidate pixel and candidate pixels adjacent to it on a lower proximate line that are used in calculating a corresponding position;

FIG. 7 shows how a corresponding position of decimal precision is calculated by a matching error interpolation method;

FIG. 8 shows a target pixel and a calculated corresponding sub-pixel position;

FIG. 9 shows how a pixel value of a pixel, in an edge region, of a high-resolution image is estimated;

FIG. 10 is a block diagram of an image processing apparatus according to a second embodiment;

FIG. 11 is a block diagram of an image processing apparatus according to a third embodiment; and

FIG. 12 is a flowchart of an example operation of the image processing apparatus according to the third embodiment.

### DETAILED DESCRIPTION OF THE INVENTION

Image processing apparatus according to embodiments of the present invention will be hereinafter described in detail with reference to the drawings. The same sections etc. are denoted by a common reference symbol and will not be described redundantly.

### Embodiment 1

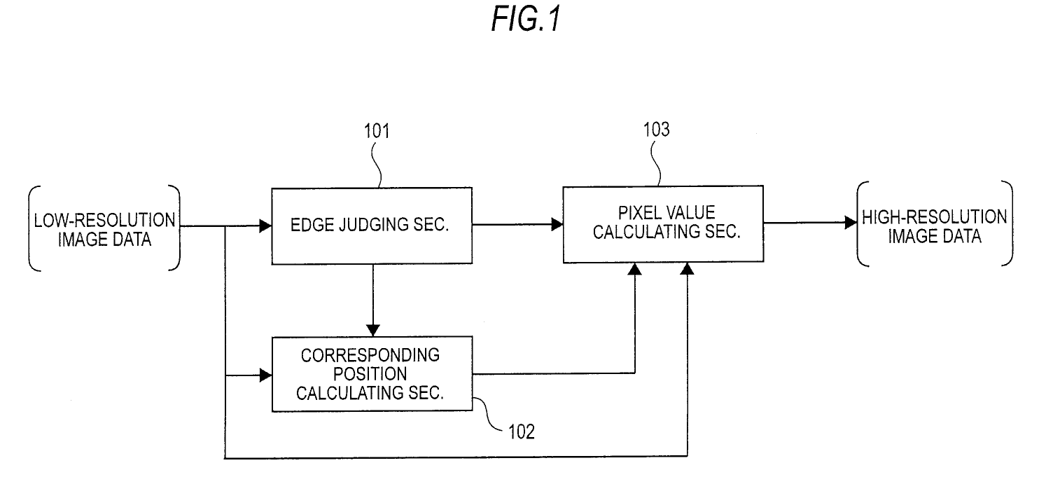

An image processing apparatus according to a first embodiment will be described below with reference to FIGS. 1-9. The image processing apparatus according to the first embodiment performs resolution-increasing processing for converting input low-resolution image data into high-resolution image data having a prescribed resolution.

### (1) Configuration of Image Processing Apparatus According to the Embodiment

FIG. 1 is a block diagram of the image processing apparatus according to this embodiment. The image processing apparatus according to the embodiment is equipped with an edge judging section 101, a corresponding position calculating section 102, and a pixel value calculating section 103.

### (1-1) Edge Judging Section 101

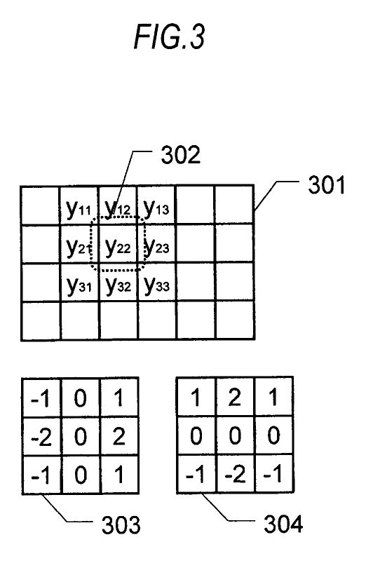

The edge judging section 101 sequentially calculates luminance value variation rates in the vicinity of individual pixels on the basis of input low-resolution image data. If the luminance value variation rate exceeds a prescribed value, it is determined that the pixel concerned is located in an edge region. The term “edge” means a portion of an image where pixel value varying points are arranged straightly and, specifically, it corresponds to an outline of a subject. It is also determined whether the edge-extending direction (hereinafter referred to as “edge direction”) in the vicinity of the pixel that has been determined to be located in an edge region is a vertical direction or a horizontal direction. A direction (binary data) judged in this manner will be hereinafter referred to as a judged edge direction of a low-resolution pixel. An edge region judging operation of the edge judging section 101 will be described below in detail with reference to FIG. 3.

FIG. 3 illustrates processing for detecting an edge region such as an outline of a subject which has a straightly arranged pixel value varying points.

It is determined whether among the pixels of a low-resolution image frame 301 a low-resolution pixel 302 is a pixel of an edge region. It is assumed that the pixels of a 3×3 block centered by the low-resolution pixel 302 have pixel values y11, y12, . . . , y33. Differentiation is performed to extract a variation between the pixel values of the low-resolution pixel 302 and nearby pixels, and it is judged that the low-resolution pixel 302 is a pixel of an edge region if the magnitude of the variation is larger than or equal to a prescribed value. Among many differentiation methods, a method using Sobel filters is employed in the embodiment.

To perform horizontal differentiation, a horizontal Sobel filter 303 is applied to the low-resolution pixel 302. More specifically, (−y11−2×y21−y31)+(y13+2×y23+y33) is calculated as a horizontal differential coefficient at the low-resolution pixel 302. Likewise, to perform vertical differentiation, a vertical Sobel filter 304 is applied to the low-resolution pixel 302. More specifically, (y11+2×y12+y13)+(−y31+2×y32−y33) is calculated as a vertical differential coefficient at the low-resolution pixel 302. The absolute values of the horizontal differential coefficient and the vertical differential coefficient are added together. If the sum is larger than or equal to a certain threshold value, it is judged that the low-resolution pixel 302 is a pixel of an edge region. An edge region is detected in the above manner.

If the output of the horizontal Sobel filter 303 is larger than that of the vertical Sobel filter 304, it can be said that the horizontal density gradient of the pixel values is larger than the vertical one. In this case, it is judged that the low-resolution pixel 302 is an edge pixel having a vertically extending edge. Conversely, if the output of the vertical Sobel filter 304 is larger than that of the horizontal Sobel filter 303, it can be said that the vertical density gradient of the pixel values is larger than the horizontal one. In this case, it is determined that the low-resolution pixel 302 is an edge pixel having a horizontally extending edge. In the following, a vertical or horizontal edge direction as a judgment result of the edge judging section 101 will be referred to as a judged edge direction.

In the above-described manners, whether each pixel of a low-resolution image frame is a pixel of an edge region is determined and whether the detected edge extends vertically or horizontally is also judged (i.e., a judged edge direction is determined).

### (1-2) Corresponding Position Calculating Section 102

The corresponding position calculating section 102 sequentially extracts, as pixels of attention, low-resolution pixels that have been judged to be located in an edge region by the edge judging section 101 and determines, on two lines (hereinafter referred to as “proximate lines”) that are adjacent to each extracted target pixel and are arranged in the judged edge direction of the target pixel, respective positions (hereinafter referred to as “corresponding positions”) where pixels having the same luminance as the target pixel are regarded to exist.

Pixels on each proximate line are extracted as candidate pixels. Matching errors each relating to similarity between the target pixel and each of the candidate pixels are calculated. A pixel having a smallest matching error among the calculated matching errors is selected as a central candidate pixel. A corresponding position, which is a sub-pixel position on the proximate line, is calculated by using the three matching errors of the central candidate pixel and the pixels adjacent to it on the proximate line.

A continuous even function is fitted to the matching errors of the three selected candidate pixels. The thus-fitted even function is regarded as an approximation of a matching error distribution on the proximate line. A position on the proximate line where the fitted function has a minimum value is determined as a corresponding position. The above method is called a matching error interpolation method.

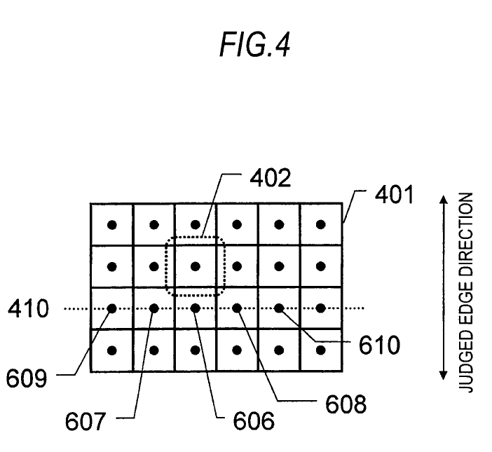

The method by which the corresponding position calculating section 102 calculates corresponding positions of decimal precision that are arranged in a judged edge direction will be described in detail with reference to FIGS. 4-8. It is assumed that the edge judging section 101 has determined that a target pixel 402 has a vertical judged edge direction. Where the judged edge direction is a vertical direction, corresponding positions on upper and lower proximate lines are to be calculated. A method by which the corresponding position calculating section 102 calculates a corresponding position on a lower proximate line 410 of the target pixel 402 will be described below in detail.

FIG. 4 shows the positions of the target pixel 402 and candidate pixels 606-610.

The target pixel 402 is a pixel that is determined to be located in an edge region by the edge judging section 101. The proximate line 410 is a lower proximate line of the target pixel 402. To calculate a corresponding position on the proximate line 410, matching errors between the target pixel 402 and the candidate pixels 606-610 are calculated.

Next, a method for calculating a matching error will be described. The corresponding position calculating section 102 of the embodiment calculates matching errors between a neighborhood block of the target pixel 402 and neighborhood blocks of the candidate pixels 606-610.

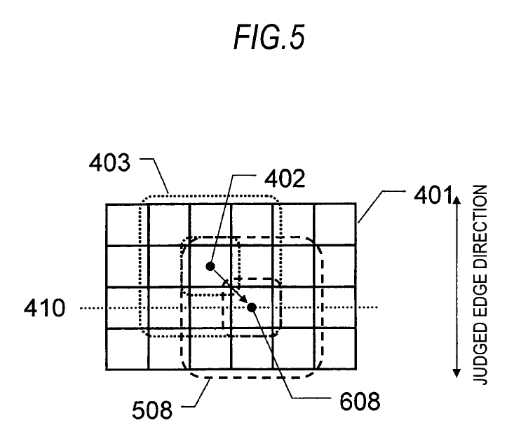

FIG. 5 illustrates a method for calculating a matching error. A target pixel region 403 and a candidate pixel region 508 are shown in FIG. 5. The target pixel region 403 is a square block that is centered by the target pixel 402 and contains several pixels of a low-resolution image frame 401 in each of the vertical and horizontal directions; for example, the target pixel region 403 is a square block of 5×5 pixels or 3×3 pixels. In the example of FIG. 5, the target pixel region 403 is a region containing 3×3 pixels. The candidate pixel region 508 is a block that is centered by the candidate pixel 608 and has the same size as the target pixel region 403. A matching error between the target pixel region 403 of the target pixel 402 and the candidate pixel region 508 of the candidate pixel 608 is calculated by a block matching method. An SSD (sum of square distances) which is the sum of the squares of the differences between the pixel values of the target pixel region 403 and those of the candidate pixel region 508, an SAD (sum of absolute distances) which is the sum of the absolute values of pixel value differences, or the like can be used as a matching error. In the embodiment, an SSD of the target pixel region 403 and the candidate pixel region 508 is calculated as a matching error of the target pixel 402 and the candidate pixel 608.

Likewise, matching errors between the target pixel 402 and the other candidate pixels 606, 607, 609, and 610 on the proximate line 410 are calculated, respectively. A candidate pixel having a smallest matching error among the calculated matching errors is selected as a central candidate pixel.

Next, a method for calculating a corresponding position on the basis of calculated matching errors will be described. A detailed description will be made below for a case that the candidate pixel 606 which is adjacent to the target pixel 402 in the judged edge direction has been selected as a central candidate pixel.

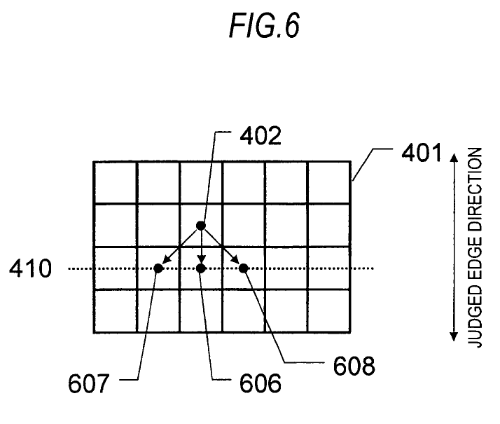

FIG. 6 shows the central candidate pixel 606 and the candidate pixels 607 and 608 which are adjacent to it on the proximate line 410.

A corresponding position is calculated on the basis of the matching errors between the target pixel 402 and the three candidate pixels 606-608.

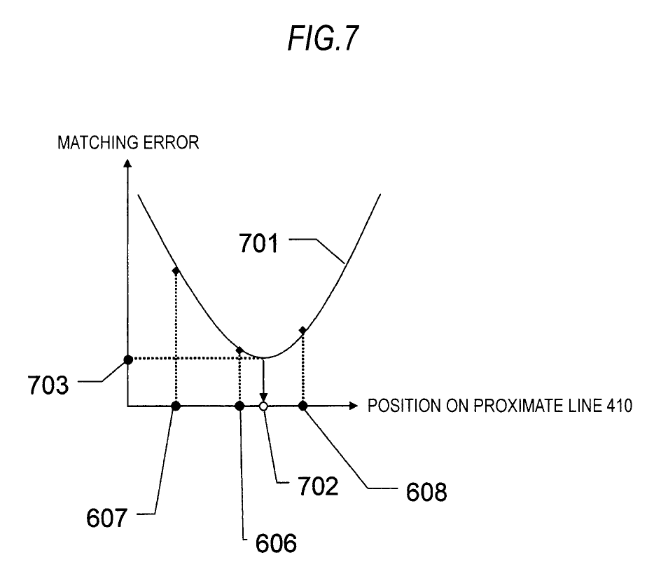

FIG. 7 is a graph showing matching errors calculated for the respective candidate pixels 606-608. The horizontal axis represents the position of each candidate pixel on the proximate line 410. The vertical axis represents the magnitude of the calculated matching error between the target pixel 402 and each candidate pixel.

Where the candidate pixel 606 is selected as a central candidate pixel, the matching errors of the candidate pixel 606 and the candidate pixels 607 and 608 which are located on the left of and on the right of the candidate pixel 606 and are adjacent to it are used for calculating a corresponding position.

First, a continuous function 701 (even function) is determined that fits the points of the three calculated matching errors of the candidate pixels 606-608. The continuous function 701 is an approximate function that approximates a distribution, on the proximate line 410, of similarity with the target pixel 402. The even function is a parabola or two straight lines that are symmetrical with respect to the matching error axis.

A position (indicated by a white circle in FIG. 7) on the proximate line 410 where the thus-determined continuous function 701 has a minimum matching error 703, that is, the similarity with the target pixel 402 is regarded as highest, is calculated as a corresponding position 702.

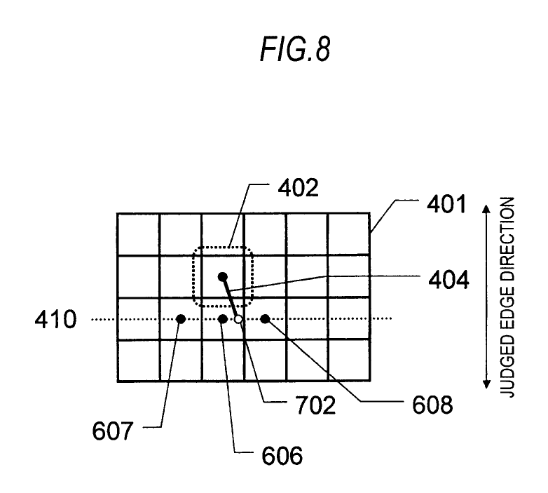

FIG. 8 shows a position in the low-resolution image frame 401 of the calculated corresponding position 702 on the proximate line 410. A line segment connecting the corresponding position 702 and the target pixel 402 is regarded as an equiluminance segment 404 having the same luminance as the target pixel 402. A corresponding position on the upper proximate line of the target pixel 402 is calculated in a similar manner.

If the edge judging section 101 judges that the target pixel 402 is a horizontal edge pixel, two corresponding positions on two proximate lines, that is, a right proximate line and a left proximate line, are calculated for the one target pixel 402. Two line segments connecting the target pixel 402 and the respective corresponding positions are regarded as equiluminance segments having the same luminance as the target pixel 402.

Although in the embodiment a matching error is calculated between a block centered by a target pixel and a block centered by a candidate pixel, a matching error may be calculated between a target pixel and a candidate pixel themselves.

### (1-3) Pixel Value Calculating Section 103

The pixel value calculating section 103 calculates an estimation pixel value of a position where a pixel should be interpolated in conversion into a prescribed resolution on the basis of equiluminance segments calculated by the corresponding position calculating section 102 and their luminance values.

Low-resolution image data, information of edge regions detected by the edge judging section 101, and corresponding positions calculated by the corresponding position calculating section 102 are input to the pixel value calculating section 103. In each edge region, two equiluminance segments that are closest to the position of a high-resolution pixel to be interpolated are selected on the basis of the information of the edge regions and an estimation pixel value of the high-resolution pixel is calculated by an interpolation method that utilizes the selected equiluminance segments. In each non-edge region, a pixel value of each estimation pixel of an estimation image is calculated by interpolation processing that is based on frame pixel values of the low-resolution image data.

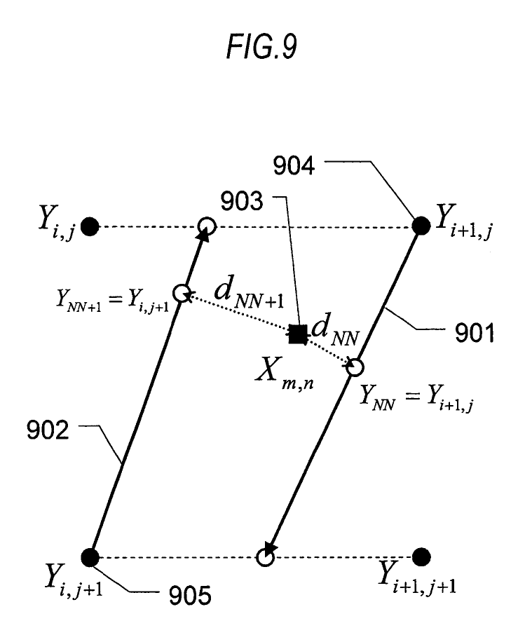

An operation of calculating an estimation pixel value of a high-resolution image will be described below in detail with reference to FIG. 9.

FIG. 9 shows how a pixel value of a pixel, in an edge region, of a high-resolution image is estimated. Equiluminance segments 901 and 902 of respective corresponding positions of decimal precision calculated by the corresponding position calculating section 102 are shown in FIG. 9. A pixel value of a new pixel 903 (i.e., a pixel of a high-resolution image whose pixel value is to be estimated) in an edge region is calculated according to

$$\begin{matrix}[ Formula 1 ] & \\ {X}_{m , n} = \frac{{d}_{NN + 1}}{{d}_{NN} + {d}_{NN + 1}} {Y}_{NN} + \frac{{d}_{NN}}{{d}_{NN} + {d}_{NN + 1}} {Y}_{NN + 1} & ( 1 )\end{matrix}$$

where X_{m,n} is the luminance value of the new pixel 905, Y_{NN} is the luminance value of a low-resolution pixel 904, Y_{NN+1} is the luminance value of a low-resolution pixel 905, d_{NN} is the distance between the new pixel 903 and a closest equiluminance segment 901, and d_{NN+1} is the distance between the new pixel 903 and another closest equiluminance segment 902 that is located on the other side of the new pixel 903 from the closest equiluminance segment 901.

A pixel value of each high-resolution pixel that is not located in an edge region is calculated by an interpolation method (3D convolution method) in which filtering is performed by using a sinc function that is based on the sampling theorem.

### (2) Operation of Image Processing Apparatus According to the Embodiment

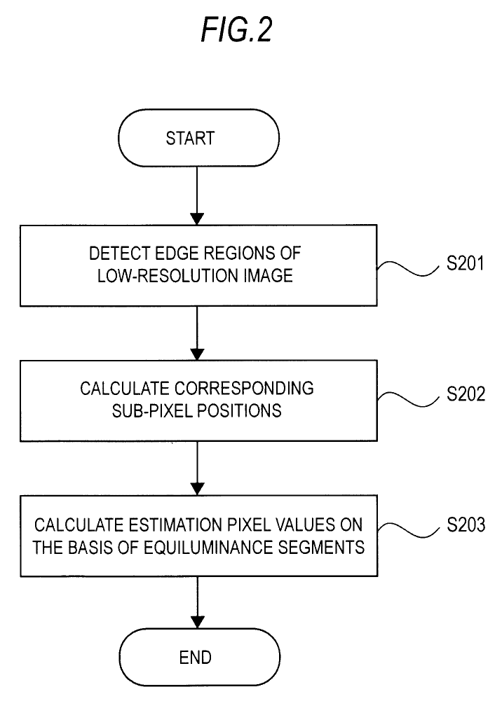

FIG. 2 is a flowchart of an operation that the image processing apparatus according to the embodiment converts low-resolution image data into high-resolution image data.

### (2-1) Step S201

First, it is judged on the basis of the pixel values of low-resolution image data whether each pixel is located in an edge region or a non-edge region. The edge detecting section 101 detects edge regions where pixel value varying points are arranged straightly and consecutively on the basis of the pixel values of the pixels of one frame. Furthermore, the edge detecting section 101 judges, in a neighborhood region including each pixel of each detected edge region, whether the edge is a vertical edge or a horizontal edge.

### (2-2) Step S202

Then, corresponding positions on respective proximate lines that are perpendicular to the judged edge direction, determined at step S201, of each target pixel. The corresponding position calculating section 102 sets, as a target pixel, each pixel of each edge region in one frame (a subject of resolution-increasing processing) of the low-resolution image data and calculates, with decimal precision, one or more corresponding positions that are arranged in the judged edge direction of the target pixel.

Each corresponding position is calculated by calculating matching errors at intervals that is equal to the pixel interval of the low-resolution image data and fitting a continuous symmetrical function to them, and employing, as a corresponding position, a position on a proximate line where the matching error takes a minimum value.

### (2-3) Step S203

Then, each estimation pixel value of a high-resolution image is calculated on the basis of equiluminance segments. In each edge region, the pixel value calculating section 103 calculates a pixel value of each estimation pixel of an estimation image by performing interpolation processing on the basis of pixel values of a frame of the low-resolution image data, equiluminance segments terminated by respective corresponding positions, and the position of the estimation pixel of the high-resolution image. In each non-edge region, the pixel value calculating section 103 calculates a pixel value of each estimation pixel of the estimation image by performing interpolation processing on the basis of pixel values of the frame of the low-resolution image data. The pixel value calculating section 103 outputs a high-resolution image formed by the estimated pixel values. The operation is thus finished.

### (3) Advantages of the Embodiment

As described above, a corresponding position on a proximate line is calculated with a sub-pixel precision on the basis of the differences between the pixel value of each target pixel of low-resolution image data and the pixel values of nearby pixels. Interpolation processing is performed by calculating pixel values of a high-resolution image by assuming equiluminance segments on the basis of the calculated corresponding sub-pixel positions. As a result, pixel values can be estimated and interpolated so as to form a sharp high-resolution image having only a small number of jaggies.

When a new pixel exists in the vicinity of a target pixel that is not located in an edge region, an estimation pixel value is calculated by an interpolation method (3D convolution method, bicubic method, or the like) in which filtering is performed by using a sinc function or a pattern-adaptive filter enlarging method.

### Embodiment 2

Next, an image processing apparatus according to a second embodiment of the invention will be described.

In the image processing apparatus according to the first embodiment, whether a target pixel is located in an edge region is judged and whether to calculate corresponding positions is determined according to a result of the above judgment. This configuration is suitably employed in an apparatus that uses a personal computer or the like and is suitable for conditional branching processing.

In the image processing apparatus according to this embodiment, the corresponding position calculating section 102 calculates corresponding positions for all low-resolution pixels, that is, irrespective of whether a target pixel is located in an edge region. In parallel with this processing, whether a target pixel is located in an edge region is judged and a judged edge direction is determined for all pixels. Then, corresponding positions for determining equiluminance segments are selected according to whether a new pixel to be interpolated is located in the vicinity of a target pixel that has been judged to be located in an edge region and a judged edge direction, and an interpolation luminance value is calculated. The configuration of this embodiment is suitably employed in an apparatus that uses an LSI or the like and is suitable for parallel processing.

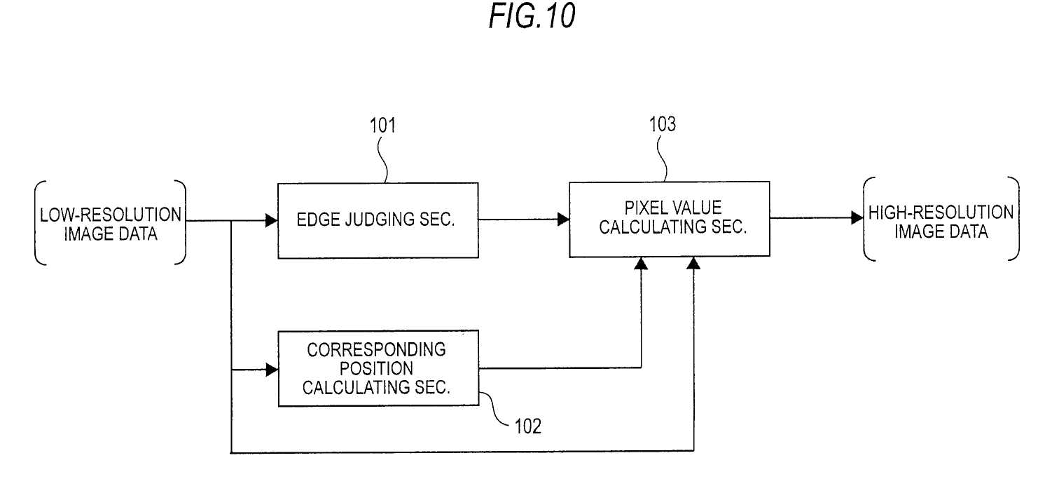

FIG. 10 is a block diagram of the image processing apparatus according to the embodiment.

In the image processing apparatus according to the embodiment, the corresponding position calculating section 102 calculates corresponding positions for all pixels rather than only pixels located in edge regions irrespective of information of edge regions detected by the edge judging section 101. Then, only corresponding positions in edge regions detected by the edge judging section 101 are selected and interpolation luminance values are calculated.

The image processing apparatus according to this embodiment allows even an apparatus that uses an LSI or the like and is suitable for parallel processing to estimate and interpolate pixel values to form a sharp high-resolution image having only a small number of jaggies.

### Embodiment 3

Next, an image processing apparatus according to a third embodiment of the invention will be described with reference to the drawings. The image processing apparatus according to this embodiment further performs emphasis processing for rendering low-resolution pixels sharper to obtain an edge-emphasized, sharp high-resolution image.

### (1) Configuration of Image Processing Apparatus of the Embodiment

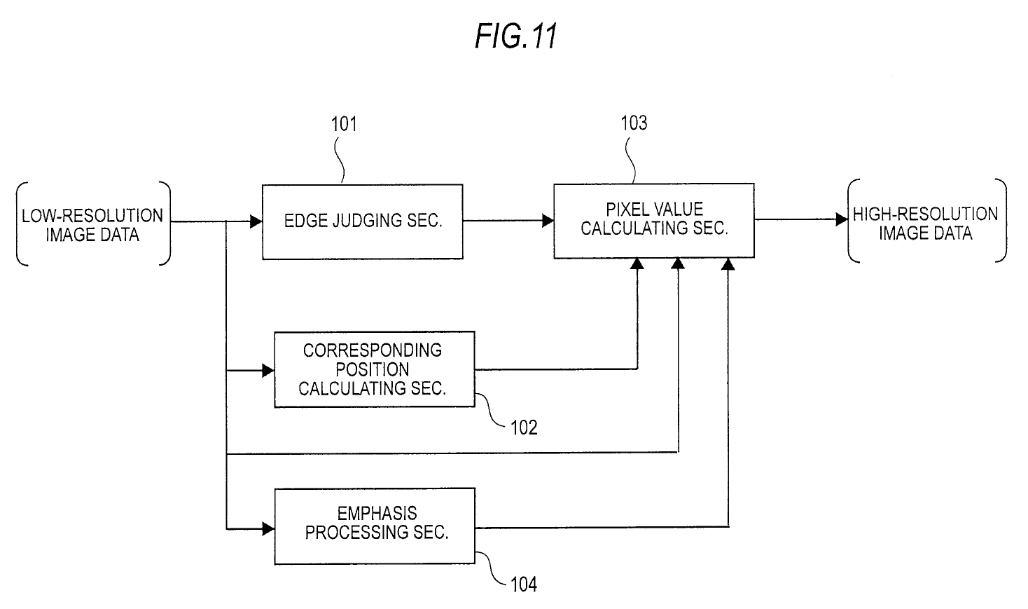

FIG. 11 is a block diagram of the image processing apparatus according to the embodiment.

The image processing apparatus according to the embodiment is additionally equipped with an emphasis processing section 104.

The emphasis processing section 104 performs emphasis processing for rendering input low-resolution image data sharper. The emphasis processing uses an enhancement filter such as an unsharpening mask. The emphasis processing section 104 outputs emphasis-processed low-resolution image data to the pixel value calculating section 103.

### (2) Operation of Image Processing Apparatus of the Embodiment

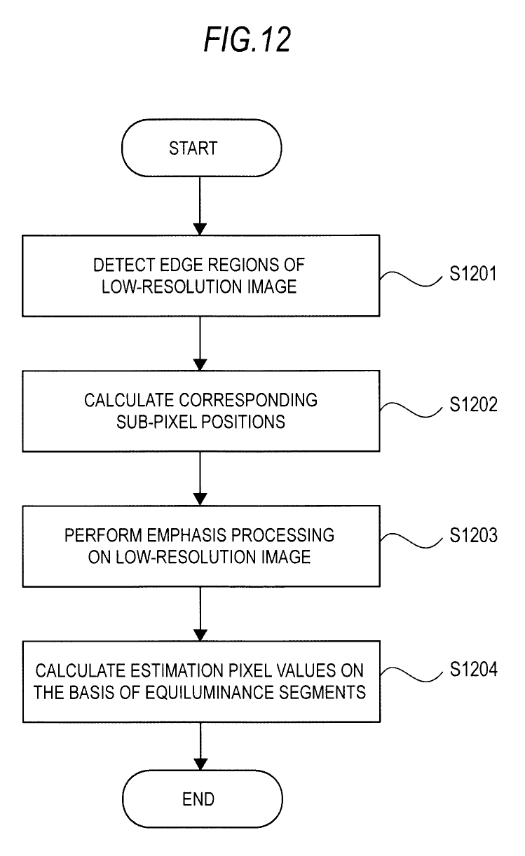

FIG. 12 is a flowchart of an operation of the image processing apparatus according to the embodiment. In the image processing apparatus according to the embodiment, a step of performing emphasis processing on the pixel values of low-resolution image data is inserted between step S202 (for calculating corresponding positions) and step S203 (for calculating interpolation pixel values) of the first embodiment. This embodiment is different from the first embodiment in that estimation pixel values to be interpolated are calculated on the basis of the luminance values of emphasis-processed low-resolution image data. Since steps S1201, S1202, and S1204 which are executed in the image processing apparatus according to this embodiment are the same as steps S201, S202, and S203, respectively, which are executed in the image processing apparatus according to the first embodiment and hence will not be described in detail.

### (2-1) Step S1201

The edge judging section 101 detects edge regions from low-resolution image data. Furthermore, the edge judging section 101 judges whether an edge in the vicinity of each pixel that has been judged to be located in an edge region is a vertical edge or a horizontal edge.

### (2-2) Step S1202

Then, the corresponding position calculating section 102 calculates corresponding positions that are arranged in the judged edge direction of each target pixel. Each corresponding position is calculated by calculating matching errors at intervals that are equal to the pixel interval of the low-resolution image data, fitting a continuous even function to them, and employing, as a corresponding position, a position on a proximate line where the matching error takes a minimum value.

### (2-3) Step S1203

Processing of emphasizing outlines of the low-resolution image data that is input to the emphasis processing section 104. Emphasis-processed low-resolution image data as well as the original low-resolution image data are output to the pixel value calculating section 103. The emphasis processing uses an enhancement filter such as an unsharpening mask.

### (2-4) Step S1204

Then, the pixel value calculating section 103 calculates estimation pixel values to be interpolated in conversion into high-resolution image data. In each edge region, the pixel value calculating section 103 calculates a pixel value of each estimation pixel of an estimation image by performing interpolation processing on the basis of pixel values of a frame of the emphasis-processed low-resolution image data, the equiluminance segments terminated by the respective corresponding positions, and the position of the estimation pixel of the high-resolution image. In each non-edge region, the pixel value calculating section 103 calculates a pixel value of each estimation pixel of the estimation image by performing interpolation processing on the basis of pixel values of the frame of the low-resolution image data that was not subjected to the emphasis processing. The pixel value calculating section 103 outputs a high-resolution image formed by the estimation pixel values. The operation is thus finished.

### (3) Advantages of the Embodiment

In the technique in which interpolation processing is performed by utilizing corresponding positions to determine equiluminance segments, the pixel values of low-resolution pixels around a high-resolution pixel are employed as pixel values of the equiluminance segments and a pixel value of the high-resolution pixel is calculated by performing weighted averaging on these pixel values. However, where a low-resolution image is blurred (i.e., their luminance values are different from true values due to blurring (dispersion)), an image including pixels that are interpolated by the resolution-increasing processing may also be blurred.

In this embodiment, interpolation pixel values are calculated on the basis of the luminance values of low-resolution image data whose edges have been sharpened by the emphasis processing. This makes it possible to generate an even sharper high-resolution image having only a small number of jaggies in edge regions.

The invention is not limited to the above embodiments themselves. In the practice stage, the invention can be implemented with their components modified without departing from the spirit and scope of the invention. For example, while the luminance values of the pixels are used in the calculations in the above embodiments, the luminance values maybe substituted by other pixel values. Such pixel values may include a luminance component and/or a color difference component in a color image. The pixel values may also include R, G, and B components in the color image.

Various inventions can be made by properly combining plural components described in the embodiments. For example, some components of one embodiment may be omitted.

Furthermore, components of different embodiments may be combined together.

Low-resolution image data to be subjected to resolution-increasing processing may be either a moving image or a still image. In each embodiment, low-resolution image data is, for example, image data taken by a camera or a cell phone, image data received by a TV receiver or a portable AV player, or image data stored in an HDD.

For example, the image processing apparatus according to each embodiment can be implemented by using a general-purpose computer as basic hardware. A program to be run may include the above-described individual functions as software modules. The program may be provided being recorded in a computer-readable recording medium such as a CD-ROM, a CD-R, or a DVD or being incorporated in a ROM or the like in advance as a file that is in an installable form or an executable form.

What is claimed is:

1. An image processing apparatus for converting a low-resolution image into a high-resolution image, comprising:
a determination module configured to determine a target pixel located in an edge region where a pixel value variation rate in the low-resolution image exceeds a given value in the vicinity of the target pixel;
an extraction module configured to extract candidate pixels from pixels on each of proximate lines that are adjacent to the target pixel;
an evaluation module configured to calculate evaluation values each relating to similarity between the target pixel and each of the candidate pixels with respect to pixel values;
an approximation module configured to assume approximation functions, each representing a distribution of the evaluation values along each of the proximate lines by using a function;
a position calculation module configured to calculate a corresponding position of the target pixel on each of the proximate lines using each of the approximation function;
a segment setting module configured to set line segments connecting each of the corresponding positions and the target pixel;
a specifying module configured to specify at least one of the line segments located in the vicinity of a new pixel in the high-resolution image; and
a calculation module configured to calculate a pixel value of the new pixel based on the pixel value of the target pixel and a distance between the new pixel and the specified line segments.

2. The apparatus of claim 1,
wherein the specified line segments include a first line segment that is closest to the new pixel and a second line segment that is closest to the new pixel among the line segments that are located on the other side of the new pixel from the first segment; and
the calculation module is configured to calculate a pixel value of the new pixel by weighting a luminance value on the first line segment and a luminance value on the second line segment according to a first distance between the first segment and the new pixel and a second distance between the second segment and the new pixel.

3. The apparatus of claim 2,
wherein the determination module is configured to determine whether an extending direction of an edge located in the vicinity of the target pixel is a vertical direction or a horizontal direction; and
the proximate lines are perpendicular to the extending direction.

4. The apparatus of claim 3,
wherein the approximation module extracts a central candidate pixel and adjacent pixels thereof from the candidate pixels on the basis of the evaluation values, the central candidate pixel having the highest similarity to the target pixel with respect to the pixel value; and
the approximation module determines the function to approximate the pixel values of the central candidate pixel and the adjacent pixels.

5. The apparatus of claim 4,
wherein the function includes an even function.

6. The apparatus of claim 1,
wherein each of the evaluation values relates to a similarity between a region in the vicinity of the target pixel and a region in the vicinity of each of the candidate pixels.

7. The apparatus of claim 1, further comprising: an emphasizing module configured to perform edge emphasis processing on the low-resolution image.

8. The apparatus of claim 7,
wherein the calculation module is configured to calculate a pixel value of the new pixel based on pixel values of pixels of the low-resolution image that is edge-emphasized.

9. An image processing apparatus for converting a low-resolution image into a high-resolution image, comprising:
a determination module configured to determine that a pixel is located in an edge region where a pixel value variation rate in the low-resolution image exceeds a given value in the vicinity of the pixel;
an extraction module configured to extract candidate pixels from pixels on each of proximate lines that are adjacent to a target pixel in the low-resolution image;
an evaluation module configured to calculate evaluation values each relating to similarity between the target pixel and each of the candidate pixels with respect to pixel values;
an approximation module configured to assume approximate functions, each representing a distribution of the evaluation values on each of the proximate lines by using a function;
a position calculation module configured to calculate a corresponding position of the target pixel on each of the proximate lines using each of the approximation function;
a segment setting module configured to set line segments connecting each of the corresponding positions and the target pixel,
when the target pixel is located in an edge region;
a specifying module configured to specify at least one of the line segments located in the vicinity of a new pixel in the high-resolution image; and
a calculation module configured to calculate a pixel value of the new pixel based on the pixel value of the target pixel and a distance between the new pixel and the specified line segments.

10. An image processing method for converting a low-resolution image into a high-resolution image, comprising:
determining a target pixel located in an edge region where a pixel value variation rate in the low-resolution image exceeds a given value in the vicinity of the target pixel;
extracting candidate pixels from pixels on each of proximate lines that are adjacent to the target pixel;
calculating evaluation values each relating to similarity between the target pixel and each of the candidate pixels with respect to pixel values;
assuming approximation functions each representing a distribution of the evaluation values on each of the proximate lines by using a function;
calculating a corresponding position of the target pixel on each of the proximate lines using each of the approximation function;
setting line segments connecting each of the corresponding positions and the target pixel;
specifying at least one of the line segments located in the vicinity of a new pixel in the high-resolution image; and
calculating a pixel value of the new pixel based on the pixel value of the target pixel and a distance between the new pixel and the specified line segments.
